(19) United States
(12) Patent Application Publication
(10) Pub. No.: US 2005/0120337 A1
(43) Pub. Date: Jun. 2, 2005

(54) Memory trace buffer

(76) Inventors: Mauricio J. Serrano, San Jose, CA (US); Ali-Reza Adl-Tabatabai, Santa Clara, CA (US); Anwar Ghuloum, Mountain View, CA (US); Dong-Yuan Chen, Fremont, CA (US); Richard L. Hudson, Northampton, MA (US)

Correspondence Address: Aslam A. Jaffery;Blakely, Sokoloff, Taylor & Zafman LLP, Suite 1300, 8055 E. Tufts Avenue, Denver, CO, 80237, US

(21) Appl. No.: 10/725,730

(22) Filed: Dec. 1, 2003

(51) Int. Cl. G06F 9/44

(52) U.S. Cl. 717/127; 717/131

(57) ABSTRACT

According to an embodiment of the invention, a method and apparatus are described for memory trace buffering. An embodiment of a processor includes an execution unit and a buffer. The buffer is to store certain data regarding each memory operation of a plurality of memory operations that are executed by the processor.

### FIELD

An embodiment of the invention relates to computer operation in general, and more specifically to a memory trace buffer.

### BACKGROUND

A computer application may include certain inefficiencies in operation. For example, a computer may include one or more cache memories to increase the speed of memory access, but certain operations may create misses in the cache memories and thus result in slower processing. However, it may be difficult to quickly and effectively determine the source of the inefficiencies.

Conventional systems may, for example, provide for capturing traces of branch events to attempt to improve branch prediction behavior. However, generally little information is captured regarding processor operations. For this reason, there often is minimal information to utilize when evaluating operations. Compiler analysis may not be sufficient to determine the sequence of events that lead up to a particular problem, and source code may not be available to establish what relationships exist between memory operations. Conventional software methods to capture a sequence of memory operations will generally be very slow and thus are of limited use in performance enhancement.

### BRIEF DESCRIPTION OF THE DRAWINGS

The invention may be best understood by referring to the following description and accompanying drawings that are used to illustrate embodiments of the invention. In the drawings:

FIG. 1 illustrates an embodiment of a memory trace buffer;

FIG. 2 illustrates an embodiment of a memory trace operation;

FIG. 3 illustrates an embodiment of filtering operations for a memory trace buffer;

FIG. 4 is a flow chart to show an embodiment of memory trace buffering processes;

FIG. 5 illustrates an embodiment of a processor including a memory trace buffer; and

FIG. 6 illustrates an embodiment of a computer environment.

### DETAILED DESCRIPTION

A method and apparatus are described for memory trace buffering.

Before describing an exemplary environment in which various embodiments of the present invention may be implemented, certain terms that will be used in this application will be briefly defined:

As used herein, “base address” means an address that is used as a reference to produce another address. The produced address may be referred to herein as an effective address.

As used herein, “effective address” means an address that is produced from a base address and other data, such as a received instruction. The term includes a virtual linear address into which a memory operation stores data or from which a memory operation reads data.

Under an embodiment of the invention, a mechanism captures data regarding dynamically executed memory operations. The mechanism may be referred to herein as a memory trace buffer. According to a particular embodiment of the invention, a memory trace buffer is a buffer that captures data, such as a sequence of instruction addresses and effective addresses, for memory operations executed by a processor.

An embodiment of the invention may include a buffer that is circular so that the buffer discards old entries. The mechanism for discarding old entries may comprise a pointer to the most recent entry. For example, the pointer may be designated as P, and the buffer may have eight entries. Thus, on arrival of a new load, the operation P=(P+1) % 8 (providing the mathematical expression P=P+1 mod 8) is performed, which may be implemented by a 3-bit counter that overflows when it reaches the maximum value 7. The entry P is overwritten with the data of the new load. However, embodiments of the invention are not limited to circular buffers and may be implemented with various types of memory structures.

In certain embodiments of the invention, additional information may be captured in the memory trace buffer. For example:

(1) A base address may also be captured to simplify the determination of the base address of a load.

(2) A loaded value may be captured.

(3) Additional runtime information for each captured memory operation, such as whether the operation caused a cache or DTLB (Data Translation Lookaside Buffer) miss, the physical address of the load, and the latency of the load, may be captured.

According to one embodiment, an alternative form of a memory trace buffer may capture more limited data, such as only a sequence of base addresses. This embodiment may be used for constructing object affinity graphs, which capture temporal relationships between objects in an object-oriented system and are used to place objects to improve spatial locality in a garbage collected runtime environment. Embodiments of the invention may be utilized in any computer architecture in which data regarding executed loads may be determined.

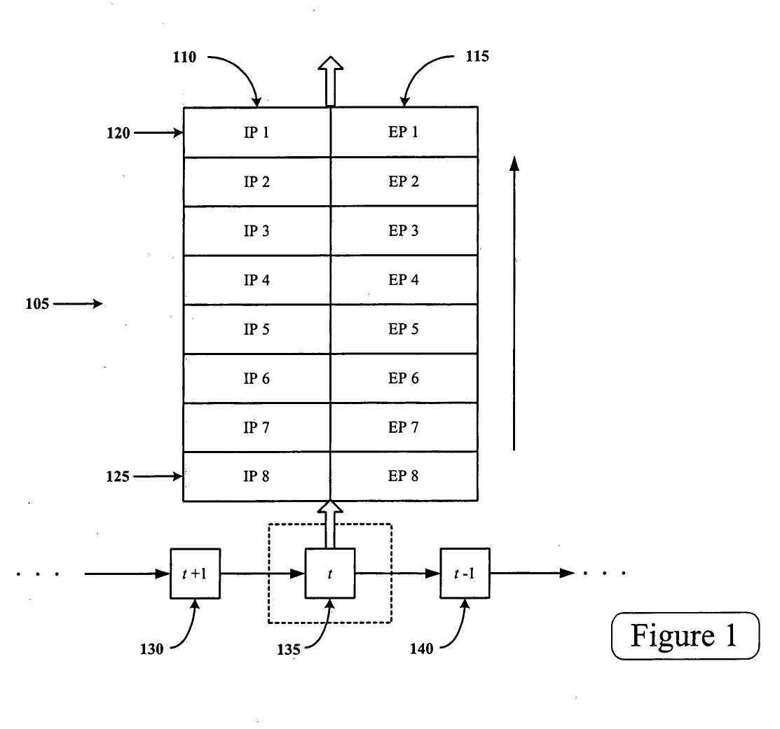

FIG. 1 shows a simplified diagram of an 8-entry memory trace buffer 105. Each entry in the memory trace buffer 105 captures the instruction address 110 and effective address 115 of an executed memory operation. For the purpose of our explanation we assume load instructions, but our method can be applied to other memory operations as well. In this illustration, Entry 1 120 is the oldest load in the buffer, and Entry 8 125 is the most recently executed load. The execution of loads is illustrated with the t−1 load 140 being the last load that has executed, the t load being the currently executed load, and the t+1 load being the next load to be executed. It is assumed that the instruction address and the effective address for the last load to be executed 140 are stored in Entry 8 125, these entries being designated as IA 8 and EA 8. When the current load 135 is executed, the oldest entry 120 in the memory trace buffer is discarded and each entry is shifted in position. Entry 2 becomes entry 1, entry 3 becomes entry 2, and continuing through the buffer. The instruction address and effective address for the most recently executed load 135 becomes Entry 8 in the memory trace buffer 105. This process repeats for each load execution that is recorded.

According to an embodiment of the invention, software may utilize information gathered by a memory trace buffer to dynamically or statically optimize memory systems for the performance of an application. For example, a managed runtime environment's garbage collector may use the information gathered by a memory trace buffer to place objects in close proximity to enhance spatial locality, which may improve data cache, memory trace buffer, and hardware prefetcher effectiveness. In another example, a profile-guided custom malloc package may use memory trace buffer information to allocate memory in a manner that improves spatial locality.

Techniques for cache and DTLB (Data Translation Lookaside Buffer) conscious object placement and memory allocation generally rely on models of an application's memory access behavior, such as temporal relation graphs and object affinity graphs. Such models may be built using information gathered by an embodiment of a memory trace buffer. A compiler may use the sequence of dependent loads gathered by a memory trace buffer to insert prefetch instructions or to create speculative software precomputation threads that prefetch data ahead of cache misses. A compiler may also use a memory trace buffer to gather profiles for stride prefetching. Performance visualization applications may use the memory trace buffer to visualize an application's memory systems performance.

Embodiments of the invention may be implemented in hardware, in software, or in any combination of hardware and software. In one embodiment of the invention buffer hardware is utilized to obtain and record data regarding executed memory operations, with the hardware then providing data points to software. The software evaluates the data points to determine relationships between the executed memory operations.

An embodiment of the invention may be implemented as software instrumentation and may gather similar information as a memory trace buffer implemented in hardware. However, the operation of software instrumentation may result in a higher performance penalty than a hardware implementation of a buffer. Software instrumentation may perturb the measurements. For example, software instrumentation may pollute the cache memory and may change timing so that the measured misses are skewed.

According to an embodiment of the invention, a memory trace buffer may be programmed to freeze or halt operations and cause an interrupt condition based on certain events. After the buffer is frozen, a handler can process the buffer. In an alternative embodiment, the memory hardware may write the frozen memory trace buffer's state to a reserved region of memory via non-polluting writes, which may then be processed. Events that may trigger the freezing of a memory trace buffer may include the following, either alone or in any combination:

(1) The last entry in the buffer results in a cache miss or a DTLB miss.

(2) The last entry in the buffer contains an invalid effective address as detected by a processor's translation mechanism. Among other uses, the presence of the invalid effective address may be used in debugging operations.

(3) The last entry in the buffer matches a particular instruction address range, such as a range of the form [start address, end address]. Among other uses, the match to a particular address range may be used to analyze the memory instructions contained in a certain program section.

(4) The effective address of the last entry in the buffer matches a particular data range, such as a range of the form [start address, end address]. Among other uses, the match to a particular address range may be used to analyze the memory instructions contained in a certain memory area.

(5) The buffer may be programmed to perform sampling by utilizing an additional counter. For example, the buffer may be frozen after N events have been recorded, which may be after N cache misses, after N cycles, or after N other types of events.

In one example, a system may operate according to the following simplified C++ program segment:

Y = X->getBuffer( )
. . .
Z = Y [4];
. . .
virtual void * Klass :: getBuffer( ) {

return data;

}

The above program segment contains three pointers, X, Y, and Z. The access to Y[4] may cause a cache miss, and there may then be an interest in tracing the sequence of pointer de-references that led to the cache miss. In this example, X was accessed to obtain a pointer to an array Y, through the field data, and Y was accessed to obtain a pointer Z by accessing the fourth element of the array. Tracking the sequence of loads that leads to this cache miss under an embodiment of the invention may assist in evaluating the program operation. For example, the runtime environment may place objects pointed to by X, Y, Z in close proximity to enhance spatial locality or the effectiveness of hardware prefetching. Further, software or hardware may trigger a prefetch sequence once the address of X is known to reduce the impact of a cache miss resulting from accessing array Y. A performance visualization tool may be utilized to visualize the relationship between a cache miss and the sequence that preceded the cache miss.

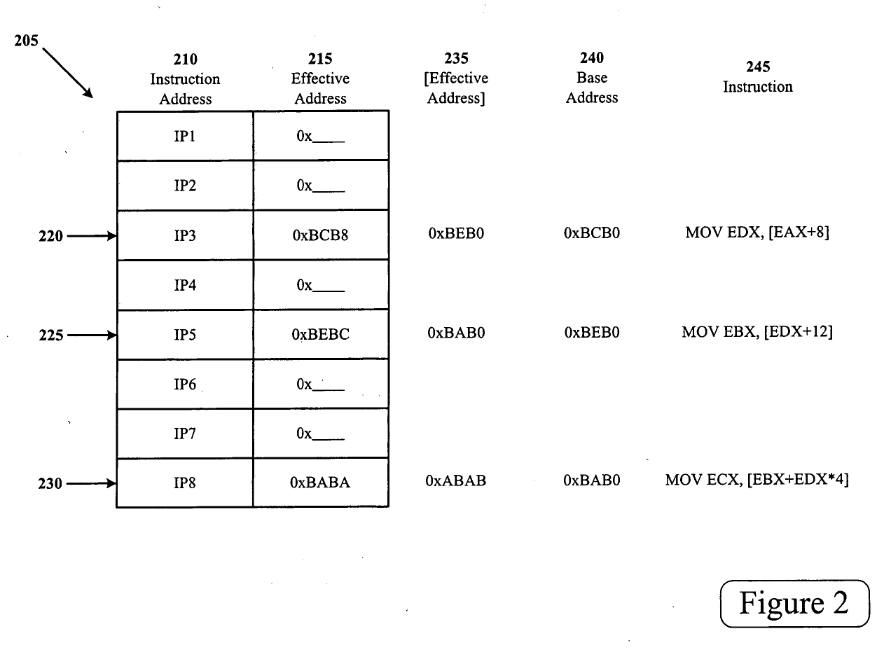

An embodiment of a memory trace operation is shown in FIG. 2. FIG. 2 relates to a computer architecture in which a base address is utilized to produce an effective address, but embodiments of the invention are not limited to this type of architecture. Embodiments of the invention may be implemented in any type of computer architecture in which data regarding executed loads may be captured. In this particular example, each entry of a memory trace buffer 205 contains captured data. The data for certain selected entries, these being entry 3 220, entry 5 225, and entry 8 230, are shown. (The contents of entries 1, 2, 4, 6, and 7 are not relevant to this particular example and thus are not shown in FIG. 2.) The processes used to identify relationships between executed loads may include the following:

(1) The memory trace buffer 205 is frozen and control of the buffer is transferred for processing.

(2) The instruction address 210 is used to locate the load instruction 245. For example, IP3 in entry 3 220 is used to find the IA32 instruction MOV EDX, [EAX+8].

(3) The instruction information is used to locate the base address of the object, shown in the base address column 240. The base addresses for entries 3, 5 and 8 are contained in registers EAX, EDX, and EBX, respectively. For entry 3 220, the base address may be obtained by subtracting 8 from the effective address. For entry 5 225, the base address may be obtained by subtracting 12 from the effective address. The computation of certain base addresses, such as the base address in entry 8 230, may be more complex. Methods of determining a base address are discussed below.

(4) The content of each effective address may be determined, as illustrated by the [Effective Address] column 235. The memory locations referred to by the [Effective Address] data may be examined or loaded.

(5) A matching operation is performed between the content of the effective address column 215, as illustrated in the [Effective Address] column 235, and the base address column 240. In the illustrated example, it may be established that the content of the effective address 235 in entry 3 220 is the same as the base address 240 in entry 5 225, both addresses being 0×BEB0. Further, the content of the effective address 235 in entry 5 225 is the same as the base address 240 in entry 8 230.

(6) The matching operation determines that the sequence of related loads in this example would be entry 3 220 followed by entry 5 225 followed by entry 8 230.

Under an embodiment of the invention, a determination of the base address may also be accomplished as follows:

(1) For the last entry in a memory trace buffer, the base address may be derived from the contents of the registers saved for the exception generated. In the example shown in FIG. 2, the content of register EBX in entry 8 may be examined to determine the base address of the array load operation. However, for a load in the memory trace buffer other than the last entry, the contents of the relevant register may have changed since the time the load was executed and thus the base address won't be derived in this manner.

(2) In a managed runtime environment, the base address may be obtained from the garbage collector. For example, the garbage collector (the process responsible for recycling system memory) may be requested to find the base address from the effective address.

(3) A memory trace buffer may include an additional field for the base address for each entry, with the base address therefore being captured for each executed load.

Under an embodiment of the invention, after a sequence of related loads has been identified, the identified related loads may be evaluated to produce certain information about operations. Information that is derived from a sequence of related loads may assist in certain processes, including:
(1) For a managed run time environment (MRTE), the runtime environment may establish information about objects, including:
   (a) A base address may be used to determine the type of an object.
   (b) An effective address may be used to determine either the field of an object or the relevant array index that is accessed.
   (c) Previous information contained in the buffer may be correlated to establish the field and object types that are involved in an event.
(2) For a non-MRTE environment, the runtime environment may establish information about allocation units.
(3) A runtime environment may place objects pointed to by the base address of certain loads in close proximity (such as sequentially in memory) to enhance spatial locality or the effectiveness of hardware prefetching.
(4) Software or hardware may trigger a prefetch sequence starting from the first load in a chain of related loads that led to a miss in memory.
(5) A performance visualization tool may be utilized to visualize the relations between a cache miss and the sequence that originated the cache miss.

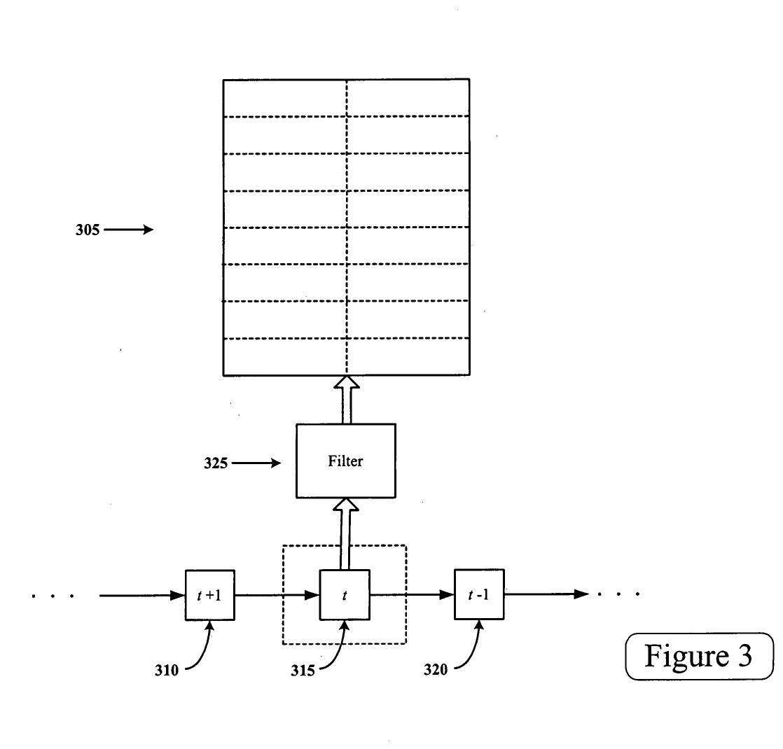

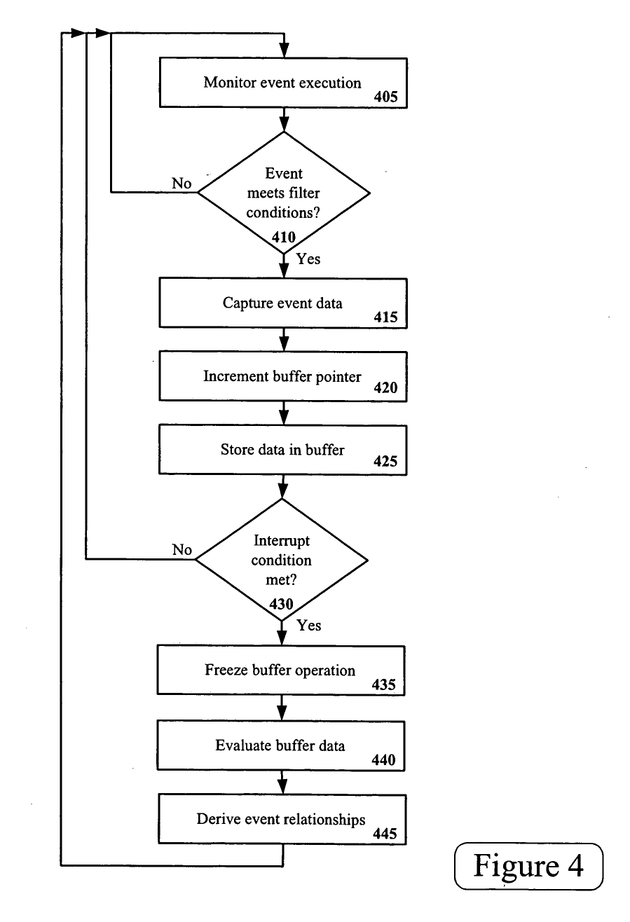

According to an embodiment of the invention, filter mechanisms may be utilized to reduce the number of memory operations that are captured in the buffer and to limit the operations that are captured to events that meet certain criteria. FIG. 3 illustrates an embodiment of the invention in which events are filtered to determine whether data regarding the events are stored in a memory trace buffer. The memory trace buffer 305 receives data regarding executed loads. The execution of loads is illustrated with the t−1 load 320 being the last load that has executed, the t load 315 being the currently executed load, and the t+1 load 310 being the next load to be executed. As the loads are executed, a filter 325 determines whether data regarding the load execution will be stored in the memory load buffer 305. The nature of the filter varies with the embodiment, and may be any mechanism for selecting or excluding certain load execution events for storage. The filtering of events may include the following:
(1) Stack accesses can be excluded from the memory trace buffer by excluding loads that use the stack or frame register as the base register. For example, the ESP or EBP registers may be excluded for IA-32 architecture systems.
(2) Instruction ranges of the form [start IP address, end IP address] may be used to either include or exclude executed loads whose instruction addresses fall within the IP range.
(3) Data ranges of the form [start effective address, end effective address] may be used to either include or exclude executed loads whose effective addresses fall within the address range.
(4) Data latency ranges of the form [minimum latency, maximum latency] can be used to either include or exclude executed loads whose miss latencies fall within the latency range.
(5) Memory operation types can be either included or excluded by checking instruction opcodes, addressing modes, destination register types (such as floating point versus integer types) or the base/index registers.
(6) Pointer identification heuristics may be used to filter out memory operations that do not load or store pointer values. For example, a determination may be made whether the loaded value is 4-byte aligned (the bottom 2 bits are zero) or represents an illegal memory page (such as having upper bits that are all zero).
FIG. 4 is a flow chart illustrating an embodiment of the invention. In this example, the execution of various events is monitored 405. If an event meets certain filter conditions 410, certain data regarding the event is captured 415. In one embodiment of the invention, the data may include an instruction address and an effective address of an executed load. If the buffer is structured as a circular buffer with a pointer, the pointer is incremented 420. The captured data is then stored in the buffer. As some point in time an event may occur that causes a freeze in buffer operation. Examples of an event may include a cache miss, a memory exception, or a programmed event that matches a particular criterion. If an interrupt condition is met 430, the operations of the buffer are frozen 435. The data that has been stored in the buffer, involving data regarding the last n stored events, is evaluated. The evaluation of the data may include deriving relationships between the executed events 445. The operation of the buffer may then again continue with the monitoring of event execution 405.

Embodiments of the invention may be structured in various ways. A memory trace buffer may be implemented within a processor or in an external memory. The operations of the buffer may be implemented by software, by hardware, or by both. Under an embodiment of the invention, a memory trace buffer may be implemented as an integral part of performance monitoring hardware in a processor. The performance monitoring hardware may be used to control the sampling and filtering of the memory trace buffer. For example, a performance monitoring counter may be programmed to freeze the memory trace buffer when the counter overflows. The interrupt handler of the performance monitoring counter may then retrieve the data in the memory trace buffer and associate with the branch trace data from performance monitoring hardware.

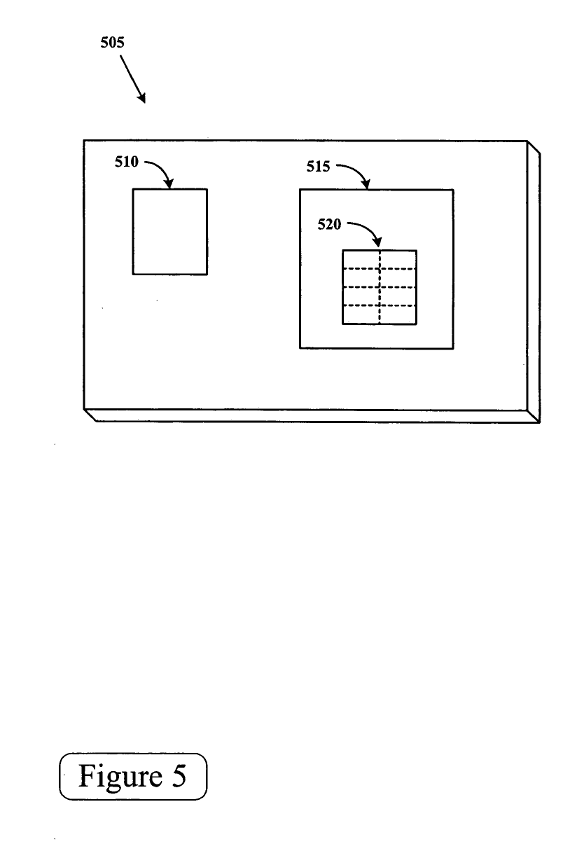

FIG. 5 is an illustration of one embodiment in which a memory trace buffer is integrated in a processor. A processor 505 includes an execution unit 510 and certain performance monitoring hardware 515 to monitor operations of the processor. Included with the performance monitoring hardware 515 is a memory trace buffer 520. The memory trace buffer 520 is used to record data regarding executed memory operations. In one example, the memory trace buffer 520 is used to store data such as instruction addresses and effective addresses of executed loads.

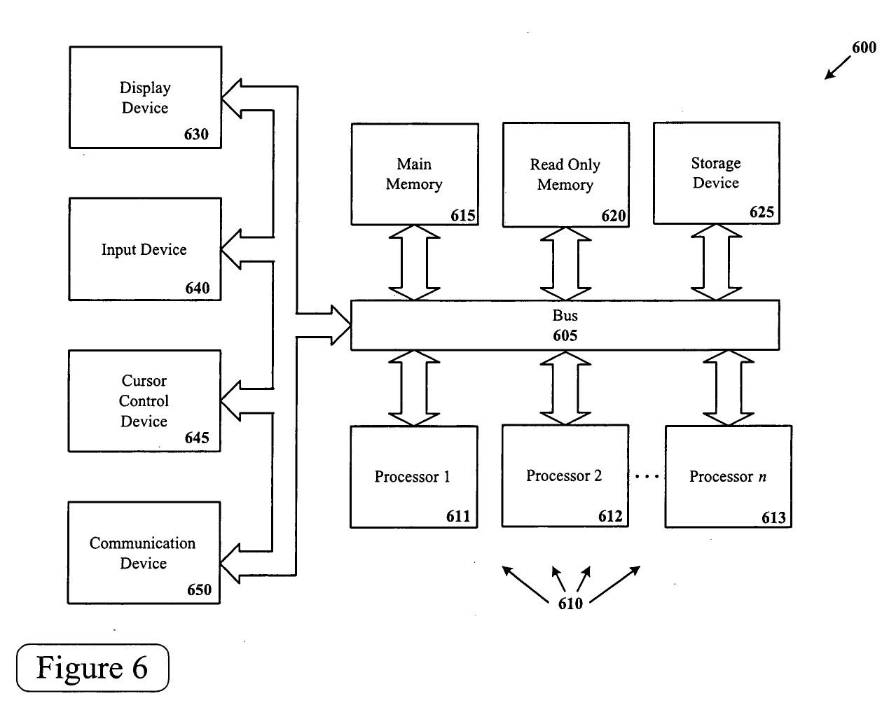

Techniques described here may be used in many different environments. FIG. 6 is block diagram of an embodiment of an exemplary computer. Under an embodiment of the invention, a computer 600 comprises a bus 605 or other communication means for communicating information, and a processing means such as one or more physical processors 610 (shown as 611, 612 and continuing through 613) coupled with the first bus 605 for processing information. Each of the physical processors may include multiple logical processors, and the logical processors may operate in parallel. According to an embodiment of the invention, each processor may include a memory trace buffer to record data regarding certain events. The memory trace buffer may be implemented as an integral part of a processor, or may be implemented externally.

The computer 600 further comprises a random access memory (RAM) or other dynamic storage device as a main memory 615 for storing information and instructions to be executed by the processors 610. Main memory 615 also may be used for storing temporary variables or other intermediate information during execution of instructions by the processors 610. The computer 600 also may comprise a read only memory (ROM) 620 and/or other static storage device for storing static information and instructions for the processor 610.

A data storage device 625 may also be coupled to the bus 605 of the computer 600 for storing information and instructions. The data storage device 625 may include a magnetic disk or optical disc and its corresponding drive, flash memory or other nonvolatile memory, or other memory device. Such elements may be combined together or may be separate components, and utilize parts of other elements of the computer 600.

The computer 600 may also be coupled via the bus 605 to a display device 630, such as a liquid crystal display (LCD) or other display technology, for displaying information to an end user. In some environments, the display device may be a touch-screen that is also utilized as at least a part of an input device. In some environments, display device 630 may be or may include an auditory device, such as a speaker for providing auditory information. An input device 640 may be coupled to the bus 605 for communicating information and/or command selections to the processor 610. In various implementations, input device 640 may be a keyboard, a keypad, a touch-screen and stylus, a voice-activated system, or other input device, or combinations of such devices. Another type of user input device that may be included is a cursor control device 645, such as a mouse, a trackball, or cursor direction keys for communicating direction information and command selections to processor 610 and for controlling cursor movement on display device 630.

A communication device 650 may also be coupled to the bus 605. Depending upon the particular implementation, the communication device 650 may include a transceiver, a wireless modem, a network interface card, or other interface device. The computer 600 may be linked to a network or to other devices using the communication device 650, which may include links to the Internet, a local area network, or another environment.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A processor comprising:
an execution unit; and
a buffer to store data regarding each of a plurality of loads executed by the processor.

2. The processor of claim 1, wherein the buffer is a part of performance monitoring hardware to monitor processor operations.

3. The processor of claim 2, wherein the performance monitoring hardware is to provide data points regarding the executed loads to software.

4. The processor of claim 3, wherein the software is to determine relationships between the executed loads based on the stored data.

5. The processor of claim 1, wherein the buffer comprises a circular buffer.

6. The processor of claim 1, wherein the data stored for each of the plurality of memory operations includes an instruction address.

7. The processor of claim 1, wherein the data stored for each of the plurality of memory operations includes an effective address.

8. The processor of claim 1, further comprising a filter, the filter determining whether the execution of each of the plurality of memory operations meets a criterion for storage.

9. The processor of claim 1, wherein the buffer is to be frozen upon the occurrence of a condition.

10. The processor of claim 9, wherein the condition comprises a miss in a cache, a memory exception, or a programmed event that matches a criterion.

11. A method comprising:
monitoring the execution of a plurality of memory operations by a processor; and
storing information in a buffer regarding the execution of the plurality of memory operations.

12. The method of claim 11, wherein the buffer is implemented in hardware.

13. The method of claim 11, further comprising determining relationships between the executed loads based on the stored information.

14. The method of claim 13, wherein software obtains some or all of the stored information from the buffer and the software is utilized to determine the relationships between the executed loads.

15. The method of claim 11, wherein the stored information includes an instruction address for each of the plurality of memory operations.

16. The method of claim 11, wherein the stored information includes an effective address for each of the plurality of memory operations.

17. The method of claim 11, further comprising determining the base address of a memory operation based on the stored information.

18. The method of claim 11, further comprising deleting the oldest information in the buffer when new information regarding the execution of a load is stored.

19. The method of claim 11, further comprising filtering each of the plurality of memory operations to determine whether to store information regarding the execution of the operation in the buffer.

20. The method of claim 11, further comprising halting the storing of information when a condition is met.

21. The method of claim 20, wherein the condition comprises a cache memory miss, a memory exception, or a programmed event that matches a criterion.

22. A system comprising:
a bus;
a processor coupled to the bus, the processor comprising:
an execution unit;
performance monitoring hardware to monitor operations of the execution unit, the processing monitoring hardware including a buffer to store data regarding each of a plurality of loads executed by the processor; and
a cache memory.

23. The system of claim 22, wherein software is allowed to access the data stored in the buffer.

24. The system of claim 23, wherein the software is to determine relationships between the executed loads based on the stored data.

25. The system of claim 22, wherein the buffer comprises a circular buffer.

26. The system of claim 22, wherein the data stored regarding each of the plurality of loads includes an instruction address.

27. The system of claim 22, wherein the data stored regarding each of the plurality of loads includes an effective address.

28. The system of claim 22, further comprising a filter, the filter determining whether the execution of each of the plurality of loads meets a criterion for storage.

29. The system of claim 22, wherein the operation of the buffer is halted upon the occurrence of a condition.

30. The system of claim 29, wherein the condition comprises a miss in the cache memory, a memory exception, or a programmed event that matches a criterion.
